(19) United States
(12) Patent Application Publication
(10) Pub. No.: US 2006/0147880 A1
(43) Pub. Date: Jul. 6, 2006

(54) Tooth implant

(76) Inventors: Michael Krumsiek, Lemgo (DE); Stefan Neumeyer, Eschlkam (DE)

Correspondence Address: SHERIDAN ROSS PC, 1560 BROADWAY, SUITE 1200, DENVER, CO, 80202, US

(21) Appl. No.: 10/533,145

(22) PCT Filed: Jun. 17, 2003
(86) PCT No.: PCT/EP03/06396

§ 371 Date: Nov. 15, 2005

(30) Foreign Application Priority Data
Nov. 5, 2002 (DE) 10251469.0

(51) Int. Cl. A61C 3/02; A61C 8/00

(52) U.S. Cl. 433/174; 433/165

(57) ABSTRACT

The invention relates to a tooth implant including a threaded enossal region 1, a middle region 2 and a coronal region 3, characterized in that the enossal region 1 includes different threaded sections.

The invention relates to a tooth implant according to the preamble of the independent claim.

In detail, the invention relates to a tooth implant including a threaded enossal region, a middle region and a coronal region.

Tooth implants are pre-known from the prior art in very different configurations. EP 0 388 576 B1 or EP 0 668 751 B1 show examples for this.

In general, in tooth implants, it is required to configure them to be able to be anchored in optimum manner in the jaw of the patient. The known tooth implants are formed one-piece or multi-piece, they mostly consist of biocompatible construction materials such as titanium or titanium alloys, aluminum or zirconium oxide ceramics or also of solid biocompatible plastics.

It is an object of the invention to provide a tooth implant, which has a high degree of anchoring stability while being of simple construction and is usable with minimized working effort.

According to the invention, the object is solved by the feature combination of the independent claim, the dependent claims show further advantageous developments of the invention.

Further, the invention relates to a dental drill for use with the tooth implant according to the invention.

In detail, according to the invention, it is thus provided that the enossal region includes different threaded sections. Therein, it is especially favorable if three different threaded sections are provided. Preferably, these can each extend over a third of the length of the enossal region.

The tooth implant according to the invention is characterized by a series of substantial advantages. Due to the configuration of the enossal region, the implant is suitable for immediate implantation and for immediate loading, since the individual different threaded sections each perform different tasks and accordingly anchor the tooth implant in the bone in different manner. Thus, with the tooth implant according to the invention, a tooth-shaped enossal design is provided, which allows for immediate implantation. By immediate loading, a high primary stability results. By the restricted micro-mobility, the immediate loading is permitted.

Particularly advantageously, it is provided that an apical threaded section has a high depth of thread with steep flanks, that a middle threaded section is provided with a conical core and a cylindrical outer diameter envelope, and that a coronal threaded section has a low depth of thread and is formed in the kind of a trapezoidal thread.

By way of the middle threaded region, a compression of the jawbone in horizontal as well as in vertical direction is achieved. Thereby, in the middle as well as in the coronal threaded section or threaded region, a high primary stability for the demanded immediate loading is achieved. The configuration of the threaded sections results in precise positive locking in the contact region between the implant and the bone.

The enossal region formed according to the invention is cylindrically stepped by the three different threaded sections, and thus simulates the cavity in the jaw upon tooth loss. The thread pitch is preferably 0.6 mm.

The individual threaded sections are configured according to the bone quality to be found in the jaw. In the apical threaded section, a high depth of thread, preferably 0.25 to 0.4 mm, is provided for increased retention in the spongious bone.

The middle threaded section has a slightly conically proceeding depth of thread. From this, the already mentioned compression in horizontal direction results when screwing-in. The thread flanks have a surface area increasing in cross-section. This results in compressing the bone in vertical direction when screwing-in. The depth of thread is approx. 60 to 80% of the depth of the thread in the apical threaded section.

The coronal threaded section has a lower depth of thread, resulting in positive locking with the solid bone. The depth of thread is approx. 30 to 50% of the depth of the thread in the apical threaded section. Thus, an increased primary stability results, which contributes to a reduced micro-mobility of the tooth implant. The flank angle of the threaded sections can be between 50° and 70°, it can vary between the individual threaded sections. The transitions of at least two threaded sections (preferably from the apical threaded section to the middle threaded section) pass conically to each other in a range of 0.3 to 0.8 mm length.

The outer diameter of the apical threaded section is lower than—as will be described below—the instrument diameter of the implant bed drill in the central region thereof. Hereby, a centering is achieved, the implant is correspondingly guided when screwing-in.

The enossal region of the tooth implant is preferably conditioned such that a micro retention and a macro retention possibility result. This can be effected by blasting with Al₂O₃ for generating the macro-roughness and/or by chemically etching for generating the micro-roughness. Additionally, a coating can be applied in this region, which promotes the osseointegration, for example calcium phosphate.

The neck region of the tooth implant is to correspond to the natural configuration of the tooth neck. In the course from apical to coronal, thus, the diameter of the implant neck is to increase conically. According to the invention, it is further provided that in the plan view no rotationally symmetric shape, but an elliptical course results.

This region of the tooth implant can be provided with a biocompatible anti-adhesive coating.

Therein, the advantage results that after adhering abutment and implant, adhering composite rests can be simply removed.

It is especially advantageous, if the tooth implant is provided with a mounted gingival sleeve in the neck region, which protects the gingiva from the not yet cured composite during adhesion of implant and abutment.

Further, according to the invention, it is provided that parallel to the key surfaces on the retention plug in the implant neck region, the garland-shaped bone-gingiva course is formed by a multiple thread. When screwing-in the implant, the bone is structured by the thread protruding outwardly such that a force introduction from the implant to the bone is possible in optimum manner. Thereby, the bone resorption after implantation is reduced.

Herein, it is especially advantageous that the retention possibility is only present where it is useful and required due to the jawbone profile. The toothing (thread) protruding outwardly also increases the primary stability. In the view of palatinal/labial, a finely structured surface is provided. For example, this one can be mechanically turned or polished. Thereby, the settlement of bacteria is substantially inhibited.

Thus, a substantial aspect according to the invention is the elliptically proceeding neck region as well as in the garland-shaped course of the transition from the implant neck to the implant shoulder.

With respect to the shoulder region of the implant, it is especially advantageous, if it has a horizontal coating surface. This provides advantages in the force introduction from the abutment to the implant. Since the ceramic abutment is far more compressively loadable than tensile-loadable, a great reduction of the fracture risk results.

The bevel provided according to the invention at the transition from implant neck to implant shoulder has two advantageous functions. On the one hand, the bevel is usable for generating the garland, wherein an angle of preferably 40° to 70° is provided. Further, a smaller adhesion gap width results from the conical course in contrast to a horizontal joining surface at the same contact pressure.

With respect to the retention plug according to the invention, it is provided that it proceeds conically. With adhered abutment, there is the possibility to grind it for divergence compensation between ideal and actual alignment of the implant axis.

According to the invention, the retention plug has preferably at least one driving surface for transmitting the screwing torque. Further, a groove can be provided as a retention possibility for a tool, for example a wrench.

According to the invention, the implant can be configured one-piece or two-piece. In a two-piece design, the implant can be provided with an inner bore and a female thread for receiving an abutment able to be screwed-in (hidden healing). A matching abutment can be screwed or adhered in.

Further, according to the invention, it is possible to provide the implant with preferably ceramic, grindable abutment being joined during manufacturing. Therein, at the upper end of the retention plug, a continuous instrument shaft for rotationally inserting the implant becomes possible. This instrument shaft or handling projection can be provided with an angle shaft end for rotational insertion by machine or with an angle shaft end and a screw-in adapter for manual rotational insertion.

According to the invention, it is also possible to provide a handling projection to the abutment, which is separable later. This provides the advantage that an adhesive connection is possible during manufacturing and the adhesion can be effected under optimum conditions.

In the gingival sleeve provided according to the invention, it proves to be especially advantageous, if it is made of a biocompatible polymer, for example of thermoplastics or elastomers or of silicone. The gingival sleeve can be pushed onto the implant neck from the work side before sterilization of the implant.

In the embodiment provided according to the invention, the gingival sleeve expands in funnel-shaped manner in the cross-section towards the coronal region.

The gingival sleeve protects the implant neck during implantation from contaminants and moisture. Further, the composite not yet polymerized cannot enter the wound region. After inserting and adhering the ceramic abutment, the gingival sleeve can be removed again in simple manner.

In the configuration of the abutment according to the invention, it is provided that it is made of a highly loadable, tooth-colored material, preferably of ceramics. Herein, a core of densely sintered ceramics and an outer body of porous ceramics can be provided. The latter is more easily grindable.

The design of the abutment can be simulated according to the teeth to be replaced, for example a front tooth or premolars/molars. Therein, according to the invention, a very good accuracy of fit to the retention plug and to the implant shoulder results, respectively. According to the invention, the abutments are provided with an allowance on the outer surfaces, which allows to process and to grind the abutment after integration, respectively.

According to the invention, it is also possible to manufacture the abutments from not tooth-colored material, for example from plastics able to be burnt-out for creating cast constructions. Further, there is the possibility to provide magnets, Q-rings, press button anchors or stem anchors to the tooth implant according to the invention in order to attach the final supply.

According to the invention, the abutment can be adhered or screwed to the implant.

With respect to the configuration of the dental drill or the instrument to be used for forming the threaded bore in the bone, it is especially advantageous if an application aid is provided, which simulates the abutment subsequently to be applied in shape and position. Thus, already in creating the pilot bore, the position of the implant (bore depth, axial alignment) can be visualized.

In the following, the invention is described by way of embodiments in association with the drawing, wherein

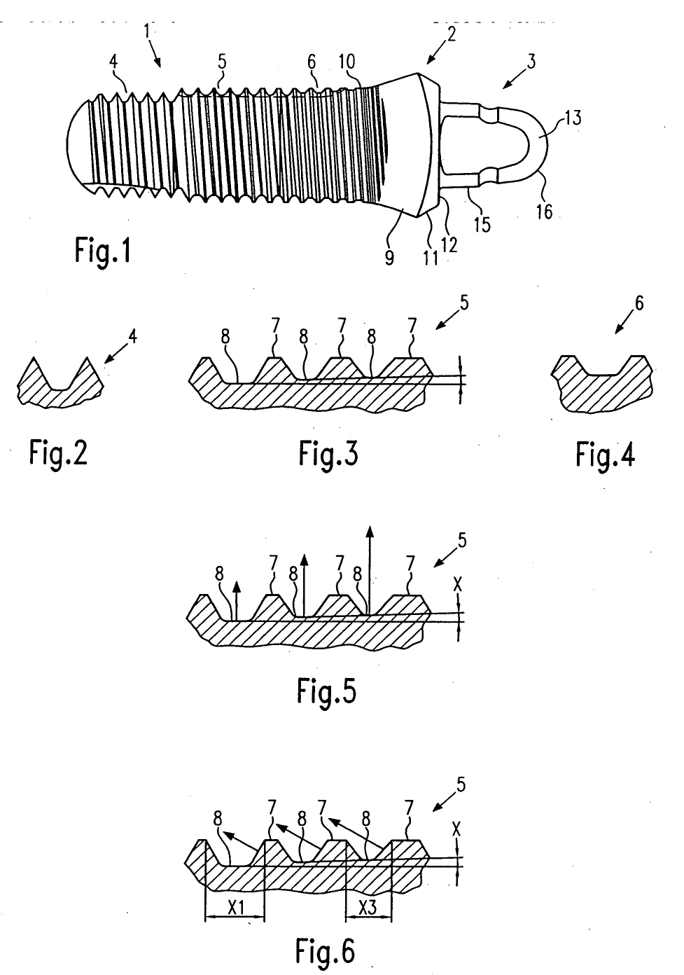

FIG. 1 is a schematic side view of a first embodiment of the tooth implant according to the invention,

FIG. 2 is an enlarged partial view of the apical threaded section,

FIG. 3 is an enlarged detailed view of the middle threaded section,

FIG. 4 is an enlarged partial view of the coronal threaded section,

FIGS. 5 and 6 are detailed illustrations of the middle threaded section shown in FIG. 3,

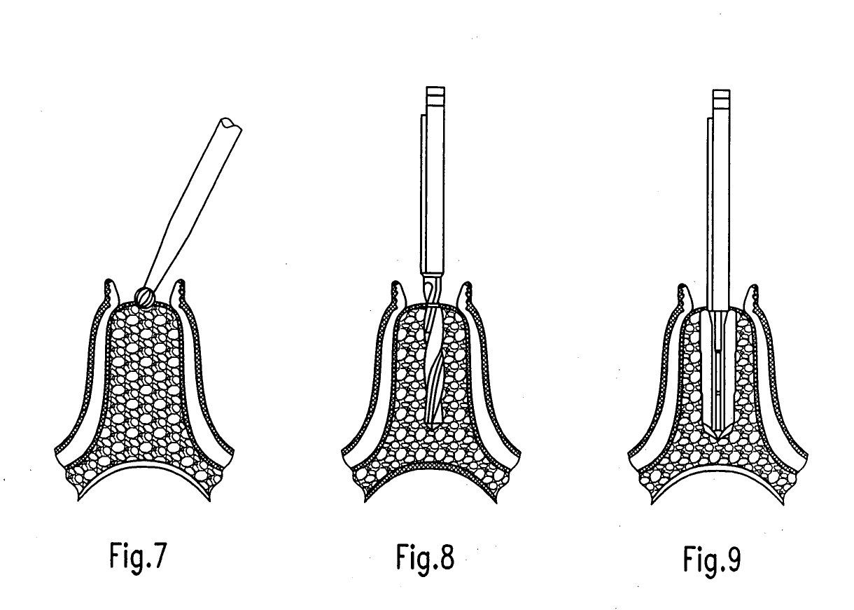

FIGS. 7 to 13 are operational procedures for inserting the tooth implant according to the invention,

FIG. 14 is a simplified side view of a dental drill according to the invention for use in a tooth implant of the type described above,

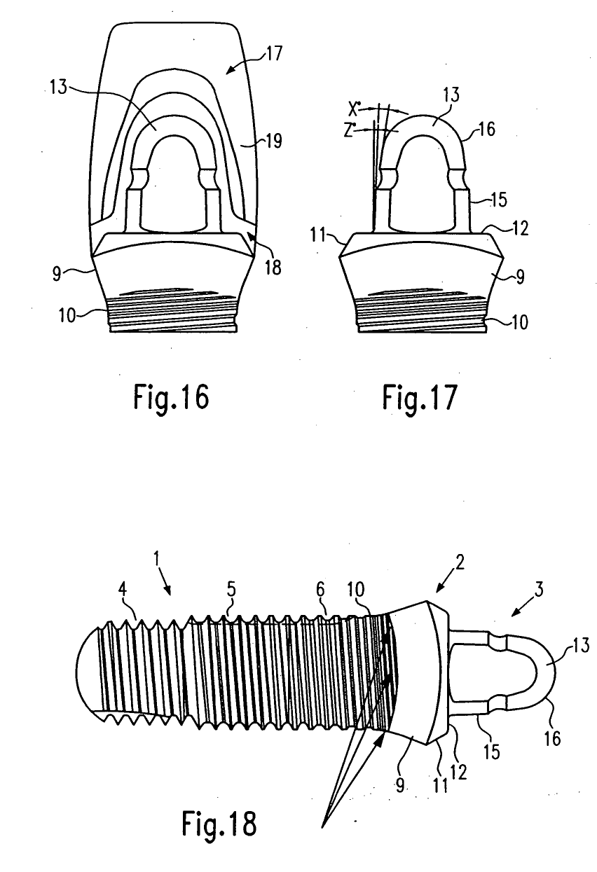

FIG. 15 is an illustration of the tooth implant according to the invention similarly to FIG. 1 with fitted gingival sleeve,

FIG. 16 is an illustration of the coronal region with fitted abutment,

FIG. 17 is a detailed illustration of the retention plug of the coronal region,

FIG. 18 is an illustration, analog to FIG. 1, for clarifying the garland-shaped course in the region of the middle region of the tooth implant,

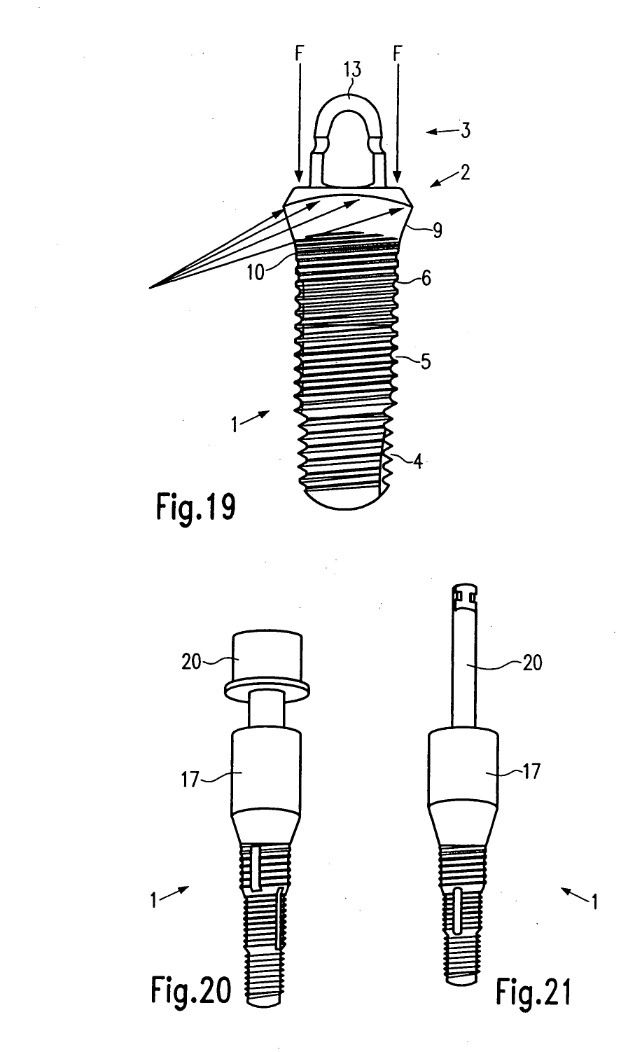

FIG. 19 is an illustration of the tooth implant, analog to FIGS. 1 and 18, with representation of the occurring loadings,

FIGS. 20 and 21 are illustrations of the tooth implant with embodiments of handling projections, and

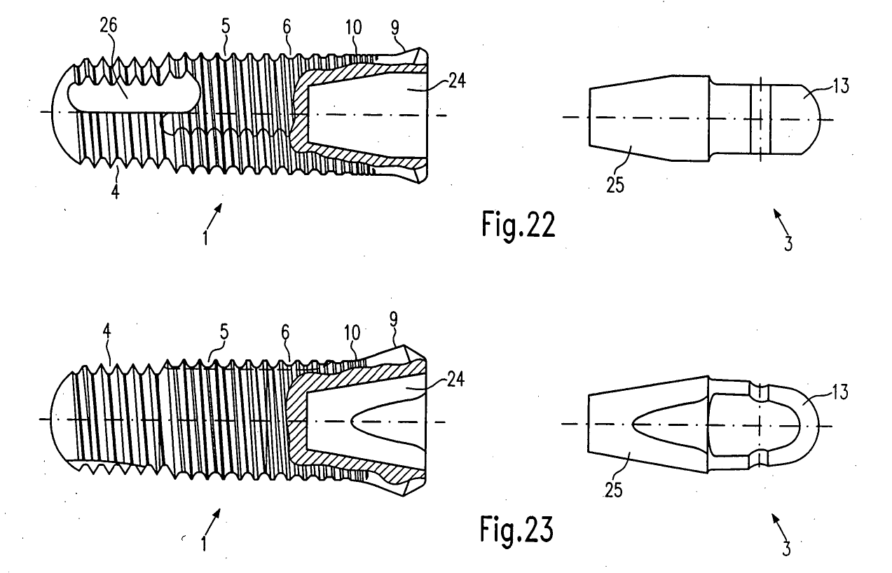

FIGS. 22 and 23 are two-piece configurations of the tooth implant according to the invention, analog to the illustration of FIG. 1.

FIG. 1 shows in the side view a tooth implant according to the invention, including an enossal region 1, a middle region 2 as well as a coronal region 3. The enossal region includes an apical threaded section 4, a middle threaded section 5 as well as a coronal threaded section 6. These each extend substantially over a third of the total length of the enossal region.

Following the enossal region, the middle region 2 is formed. This region includes a thread 10 of a conically expanding neck region 9, as well as a following implant shoulder 11 including a coating surface 12 oriented perpendicularly to the longitudinal axis of the tooth implant.

The coronal region 3 includes a retention plug 13, which includes a conical base region 15 as well as a conically beginning head region 16 following thereto, as is to be described below in association with FIG. 17.

In FIG. 2, a portion of the apical threaded section 4 is illustrated enlarged. This section includes a thread with a high depth of thread for increased retention in the spongious bone.

As shown in FIG. 5, the following middle threaded section 5 is provided with a conical core formed by the base surfaces of the flutes 8. Thus, the thread base is conical. Thereby, the increasing radial loading of the bone, indicated by the arrows in FIG. 5, results when screwing-in the tooth implant.

In FIG. 4, the coronal threaded section is illustrated. It includes a low height of thread with relatively great width of the flutes.

FIG. 6 shows further that the width of the flutes increasingly decreases, two regions X1 and X3 are represented, from which the decreasing width results. This decrease of the width results not only from a decrease of the width of the flutes or the base regions thereof, respectively, but also from an increase of the width of the thread bridges 7. Hereby, an additional anchoring and force introduction by the thread flanks results, as is illustrated in FIG. 6 by the inclined arrows.

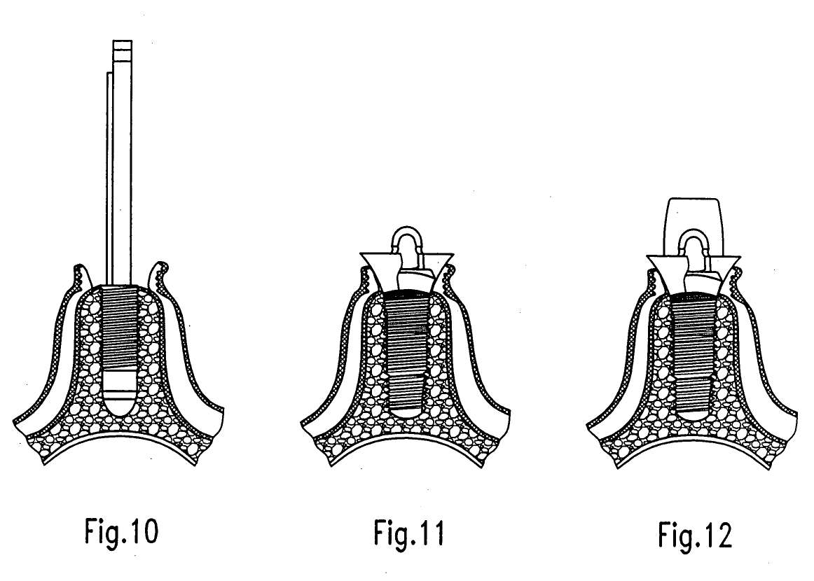

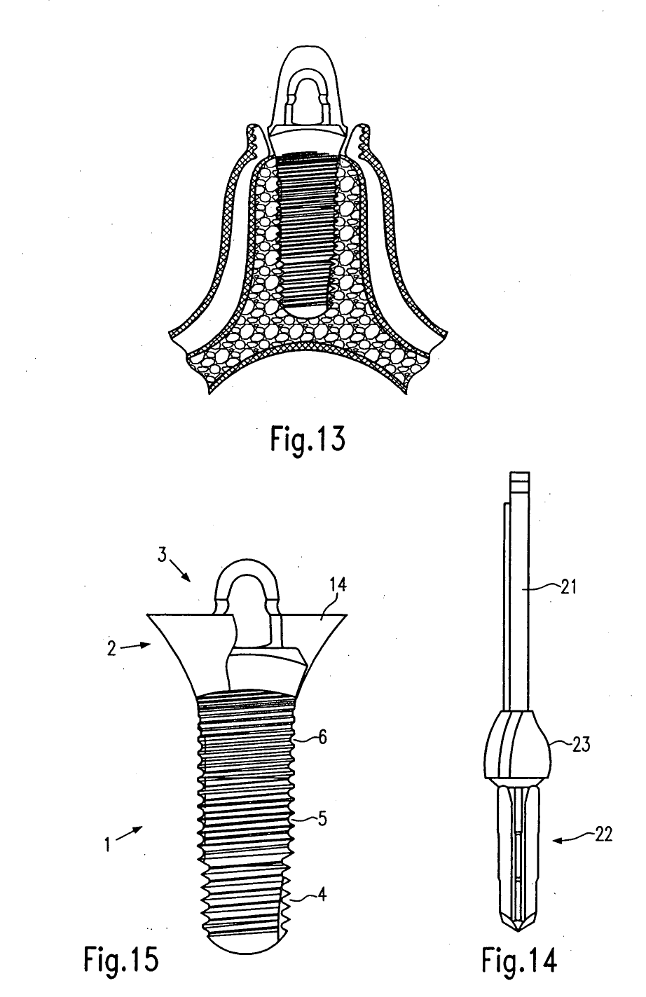

FIGS. 7 to 13 show the different treating procedures, which are possible in one session. Therein, in FIGS. 7 and 8, first the introduction of a pilot bore is represented. FIG. 9 shows the introduction of an implant bed bore, wherein the stepped contour of the threaded sections provided according to the invention is already formed by means of the implant bed drill. Subsequently, as illustrated in FIG. 10, the thread is cut. According to FIG. 11, subsequently, the tooth implant according to the invention is screwed-in with the gingival sleeve. FIG. 12 shows the adhesive attachment of the ceramic abutment. The treatment step of FIG. 13 shows that the gingival sleeve has been removed. The ceramic abutment is grinded, the composite rests are removed. Subsequently, a mold is made, a provisional corona of temporary composite is created. This temporary composite serves as a shock absorber in the transmission of the chew forces into the implant and hence into the jaw (see Gerd K. H. Fallschlüssel: Zahnärztliche Implantologie, Wissenschaft und Praxis, Quintessenz Bibliothek 1986). Subsequently, the definite supply is made and integrated. It results that the introduction of the tooth implant as well as a provisional supply can thus be effected within one session. From this, a substantial relief of the dentist results.

FIG. 14 shows in schematic lateral illustration the implant drill shown for example in FIG. 9. The implant drill includes a usual shaft 21 as well as an operational region 22, which corresponds to the enossal region of the tooth implant in its stepping and its dimensioning, as described in association with FIG. 9. According to the invention, additionally, an application aid 23 is attached, which is detachable from the shaft 21 and suggests to the dentist the shape and positioning of the ceramic abutment to be applied subsequently. Thus, in the preparation, the position of the definite supply is already recognizable.

In FIG. 15, the gingival sleeve 14 already indicated in FIGS. 11 and 12, is illustrated in enlarged representation. The gingival sleeve 14 consists of a biocompatible elastomer, for example of silicone. It is mounted during manufacturing and serves for aiding in the adhesive attachment of the ceramic abutment. Therein, it protects from contaminants and from moisture.

FIG. 16 clarifies the two-layered construction of the ceramic abutment 17 provided according to the invention. In the illustrated embodiment, the abutment includes a core 18 of densely sintered ceramics as well as an outer body 19 of porously sintered ceramics. Both ceramics are adhered to each other by means of a composite. The porously sintered ceramics are more easily grindable and processable, while the densely sintered ceramics provide advantages in applying the forces to the corona of the supply, while the densely sintered ceramics transmit the occurring forces from the corona to the implant.

As shown in FIG. 17, the retention plug 13 is entirely formed conically. In its base region 15, it includes a conicity, which is represented in FIG. 17 by “Z”. Following the base region, in the head region a conicity is provided, which is illustrated in FIG. 17 by “X”. The conicity X is greater than the conicity Z. Following the conical region of the head region 16, this one is rounded, as is evident from FIG. 17.

In FIG. 18, in addition to the illustration of FIG. 1, the configuration of the implant neck is clarified. This neck includes the already mentioned thread 10, which is formed as an outwardly protruding multiple thread in the approximal region. This thread serves for avoiding the bone resorption by early loading the bone along the bone-gingiva course. The arrows in FIG. 18 show the garland-shaped course of the roughed region of the implant neck. As mentioned, the thread 10 is only provided laterally at the intermediate regions to the adjacent teeth.

From the illustration of FIG. 19, the force introduction from the abutment to the implant (see arrows F) results. Further, by the four additional arrows, the formation of the garland of the implant neck is illustrated. As a whole, by this configuration, a lower adhesion gap width results at the same contact pressure compared to the embodiments known from the prior art.

FIGS. 20 and 21 show configurations of the tooth implant according to the invention, wherein a grindable ceramic abutment 17 is already mounted during manufacturing. This abutment is provided with an additional handling projection 20, which can consist of ceramic material (FIG. 20), or be designed in form of a metallic plug (FIG. 21). In both cases, the handling projection 20 is provided with a bevel and/or a groove in order to be able to mechanically or manually screw-in the tooth implant. The handling projection 20 is separable after inserting the tooth implant.
Force transmission in rotational insertion by machine: through the angle shaft end (area)
Force transmission in manual rotational insertion: through the multi-edge end

FIGS. 22 and 23 show embodiments according to the invention, wherein the tooth implant is formed two-piece. Therein, the enossal region 1 is provided with a front-side recess 24, into which a projection 25 integrally connected to the retention plug 13, is insertable. The projection 25 can be screwed-in or adhered.

As can be seen from FIG. 22, at least one of the threaded sections 4 to 6 of the enossal region 1 has a groove 26 extending in axial direction. The depth of the groove is greater than the depth or height of thread, respectively. Preferably, also a plurality of such grooves can be provided distributed about the circumference. The grooves each form a throat such that the threaded sections 4 to 6 are each formed as self-threading threads. At each of the threaded sections 4 to 6, one or more grooves can be provided respectively. Per threaded section, for example, the grooves are offset to each other by 120°. The individual grooves or throats of the individual steps of the threaded sections 4 to 6 could also be offset to each other, for example by 60°. Thereby, the individual threaded sections 4 to 6 are each self-threading so that an especially secure anchoring is effected.

The invention is not restricted to the shown embodiments, rather, diverse variation and modification possibilities result within the scope of the invention.

### LIST OF REFERENCE SYMBOLS

1 enossal region
2 middle region
3 coronal region
4 apical threaded section
5 middle threaded section
6 coronal threaded section
7 thread bridges
8 flutes
9 neck region
10 thread
11 implant shoulder
12 coating surface
13 retention plug
14 gingival sleeve
15 base region 13
16 head region 13
17 abutment
18 core
19 outer body
20 handling projection
21 shaft
22 operational region
23 application aid
24 recess
25 projection
26 groove

1. A tooth implant including a threaded enossal region, a middle region and a coronal region, wherein the enossal region includes different threaded sections.

2. The tooth implant according to claim 1, wherein said threaded enossal region comprises three different threaded sections.

3. The tooth implant according to claim 2, wherein the three threaded sections each extend substantially over a third of the length of the enossal region.

4. The tooth implant according to claim 2, wherein said threaded enossal region includes an apical threaded section, said apical threaded section having a high depth of thread with steep flanks, a middle threaded sections with a conical core and a cylindrical outer diameter envelope, and a coronal threaded section having a low depth of thread, wherein at least said coronal threaded section comprises a trapezoidal thread.

5. The tooth implant according to claim 4, wherein the middle threaded section has a depth of thread of 60 to 80% of the depth of thread of the apical threaded section.

6. The tooth implant according to claim 1, wherein the coronal threaded section has a depth of thread of 30 to 50% of the depth of thread of the apical threaded section.

7. The tooth implant according to claim 4, wherein the middle threaded section has thread bridges becoming wider and flutes becoming more narrow at substantially the same pitch from the apical threaded section to the coronal threaded section.

8. The tooth implant according to claim 7, wherein the middle threaded section includes a conical base body defined by the flutes.

9. The tooth implant according to claim 4, wherein the outer diameter of the apical threaded section is smaller than the outer diameter of the middle and the coronal threaded section.

10. The tooth implant according to claim 1, wherein the middle regions of the implant includes a neck region conically increasing in the course from apical to coronal.

11. The tooth implant according to claim 10, wherein the neck region is elliptical in cross-section.

12. The tooth implant according to claim 10, wherein the neck regions is provided with a multiple thread.

13. The tooth implant according to claim 12, wherein the thread is respectively formed laterally at the neck region and extends in the inserted implant in the approximal region to the adjacent teeth.

14. The tooth implant according to claim 10, wherein the neck region is provided with an anti-adhesive coating.

15. The tooth implant according to claim 10, wherein a transition from the neck region to the implant shoulder is formed garland-shaped.

16. The tooth implant according to claim 15, wherein a bevel is provided at the transition from the neck region to the implant shoulder.

17. The tooth implant according to claim 15, wherein the implant shoulder has a flat coating surface perpendicular to the longitudinal axis of the implant.

18. The tooth implant according to claim 1, wherein the coronal region includes a conical retention plug.

19. The tooth implant according to claim 1, wherein a detachable gingival sleeve is arranged at the middle regions.

20. The tooth implant according to claim 18, wherein the retention plug is formed conically and has a lower conicity in its base region and a greater conicity in its head region.

21. The tooth implant according to claim 18, wherein a ceramic abutment is applied to the retention plug.

22. The tooth implant according to claim 21, wherein the abutment has a cored made of densely sintered ceramics and an outer body made of porously sintered ceramics.

23. The tooth implant according to claim 21, wherein a removable handling projections is attached to the retention plug.

24. The tooth implant according to claim 1, wherein at least one of the threaded sections of the enossal region is provided with at least one groove extending at least over a partial region of the axial length and forming a throat.

25. The tooth implant according to claim 24, wherein multiple grooves are provided in said enossal region and, are disposed offset to each other about a circumference of the implant.

26. The tooth implant according to claim 24, wherein the depth of the groove is greater than the respective height or depth of thread.

27. A dental drill for use with a tooth implant according to claim 1, comprising a shaft and an operational region the shape of which is adapted at least to the enossal region of the tooth implant, wherein an application aid in the form of the ceramic abutment is disposed on the shafts adjacent to the operational region.
